(19) United States
(12) Patent Application Publication
(10) Pub. No.: US 2015/0195361 A1
(43) Pub. Date: Jul. 9, 2015

(54) STREAMING SYSTEM AND NODE DEVICE USED IN STREAMING SYSTEM

(71) Applicant: FUJITSU LIMITED, Kawasaki-shi (JP)

(72) Inventor: Miwa Shimada, Kawasaki (JP)

(21) Appl. No.: 14/542,927

(22) Filed: Nov. 17, 2014

(30) Foreign Application Priority Data
Jan. 9, 2014 (JP) 2014-002317

(51) Int. Cl. H04L 29/08; H04L 29/06

(52) U.S. Cl. CPC H04L 67/14; H04L 65/60

(57) ABSTRACT

A node device used in a streaming system that provides a streaming service includes: a measurement unit configured to measure a first response time representing a round trip time with respect to a first node device that is a source of streaming data; a confirmation request generator configured to transmit a confirmation request for confirming whether delivery of streaming data is available to a node device within a specified range; and a transmitter configured to transmit a delivery request to a second node device that returns a confirmation response corresponding to the confirmation request during a period from when the confirmation request generator transmits the confirmation request until when the first response time elapses.

### CROSS-REFERENCE TO RELATED APPLICATION

This application is based upon and claims the benefit of priority of the prior Japanese Patent Application No. 2014-002317, filed on Jan. 9, 2014, the entire contents of which are incorporated herein by reference.

### FIELD

The embodiments discussed herein are related to a streaming system and a node device used in the streaming system.

### BACKGROUND

Streaming delivery (or streaming) has spread as a method of delivering image data. Streaming delivery allows terminal devices to play an image while downloading the image data file. Because of this, streaming delivery can realize live delivery. Also, even when the size of an image data file is large, terminal devices can play the image without large-capacity storage.

P2P (peer to peer) communication has been implemented in practical use as a communication scheme for providing streaming delivery. In P2P communication, a plurality of terminal devices are treated equally when they conduct communications. In other words, each terminal device can operate as a receiver which receives data, and can also operate as a transmitter which transmits (or forwards) data to other devices. Because of this, P2P communication can provide a flexible network.

A streaming system for providing streaming delivery that utilizes P2P has a root node device. A root node device manages joined node devices, which receive streaming data provided by the streaming service. When a new node device (referred to as a newly-joined node device) is to receive the streaming service, that newly-joined node device transmits a join request to the root node device. The root node device provides candidate parent node information to the newly-joined node device. Then, the newly-joined node device selects a parent node device using the candidate parent node information and receives streaming data from that parent node device.

Note that, as a related art, an information streaming system has been proposed that selects the communication route that is able to transmit information with the highest efficiency from a server to a user so as to improve the efficiency of communication network resources. Also, a server system has been proposed that makes it possible to maintain a delivery network employing a P2P-based relay scheme in an appropriate condition (For example, Japanese Laid-open Patent Publication No. 2013-118425 and Japanese Laid-open Patent Publication No. 2011-150618).

In P2P streaming delivery, a joined node device can receive streaming data from a parent node device that the joined node device selected by utilizing candidate parent node information. However, it is not always possible for a joined node device to select the most appropriate or preferable node device as a parent node device. In some cases, for example, a joined node device receives streaming data from a node device located in a distant place even when a node device that can deliver streaming data locates close to the joined node device. In such a case, the streaming data may be delayed, and communication resources may be wasted.

### SUMMARY

According to an aspect of the embodiments, a node device used in a streaming system that provides a streaming service includes: a measurement unit configured to measure a first response time representing a round trip time with respect to a first node device that is a source of streaming data; a confirmation request generator configured to transmit a confirmation request for confirming whether delivery of streaming data is available to a node device within a specified range; and a transmitter configured to transmit a delivery request to a second node device that returns a confirmation response corresponding to the confirmation request during a period from when the confirmation request generator transmits the confirmation request until when the first response time elapses.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1-5 illustrate an outline of operations of a video streaming system;

FIG. 6 is a block diagram illustrating functions of a node device;

FIG. 7 is a flowchart illustrating operations of the node device;

FIG. 8 is a sequence diagram in which a preferable parent node device is selected; and

FIG. 9 illustrates an example of a hardware configuration of a node device according to the embodiment of the present invention.

### DESCRIPTION OF EMBODIMENTS

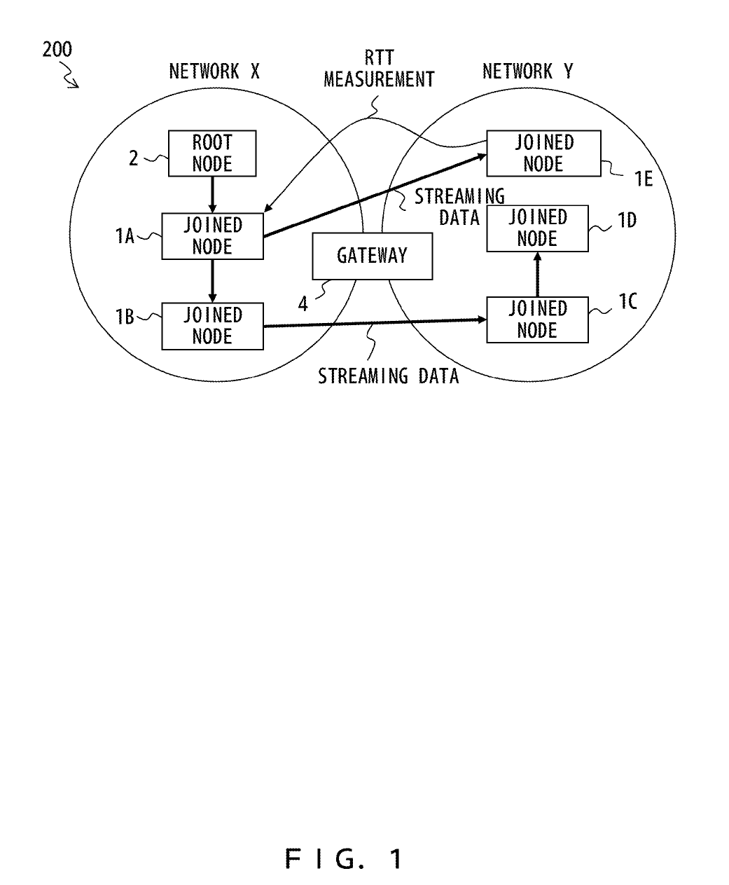

FIGS. 1-5 illustrate an outline of operations of a video streaming system 200 according to an embodiment of the present invention. The video streaming system 200 can provide a streaming service in response to a request from a user.

The video streaming system 200 includes a plurality of node devices. Each node device can join a streaming service provided by the video streaming system 200. In this example, node devices 1A, 1B, 1C, 1D and 1E have joined the streaming service as illustrated in FIG. 1. In other words, node devices 1A, 1B, 1C, 1D and 1E are respectively receiving streaming data. In the description below, a node device that has joined a streaming service may be referred to as “joined node device (or joined node)”.

The video streaming system 200 also includes a root node device 2. The root node device 2 manages the states of streaming delivery. For example, the root node device 2 manages a delivery tree that represents the connection states of joined node devices. In other words, the root node device manages routes used for delivering streaming data to respective joined node devices. The root node device 2 is located in the most upstream stage in the streaming delivery in this example. The root node device 2 obtains image data from a content server and performs streaming delivery to joined node devices. Note that a content server may operate as a root node device.

Each node device has a function of realizing P2P communication. Streaming data transmitted from the root node device 2 is delivered to respective joined nodes via one or a plurality of joined node devices. In the example illustrated in FIG. 1, the root node device 2 transmits streaming data to joined node device 1A. Joined node device 1A forwards the streaming data to joined node devices 1B and 1E. Similarly, joined node device 1B forwards the streaming data to joined node device 1C, and joined node device 1C forwards the streaming data to joined node device 1D. Through this streaming, joined node devices 1A-1E can roughly simultaneously receive the image data transmitted from the root node device 2.

Each node device is accommodated in a router. In this example, a plurality of node devices accommodated in each router form a network. For example, joined node devices 1A and 1B and the root node device 2 belong to network X, while joined node devices 1C, 1D and 1E belong to network Y, as illustrated in FIG. 1. In each of the networks X and Y, the distance between node devices is one hop. Note that networks X an Y are connected to each other via a gateway 4.

In the video streaming system 200, each of joined node devices 1A-1E decides whether or not it is receiving streaming data from a preferable parent node device. In other words, each of joined node devices 1A-1E decides whether or not it has selected a preferable parent node device. Note that a “parent node device” (or a “parent node”) represents a source node device of streaming data. For example, the parent node device of joined node device 1D is joined node device 1C, and the parent node device of joined node device 1E is joined node device 1A. Hereinafter, description will be given for a case where it is decided whether or not joined node device 1E is receiving streaming data from a preferable parent node device.

Joined node device 1E measures Round Trip Time (RTT) with respect to the parent node device as illustrated in FIG. 1. In other words, joined node device 1E measures the RTT between joined node device 1E and joined node device 1A. The RTT is measured by for example transmitting a Ping from joined node device 1E to joined node device 1A. However, RTT may be measured by a different method.

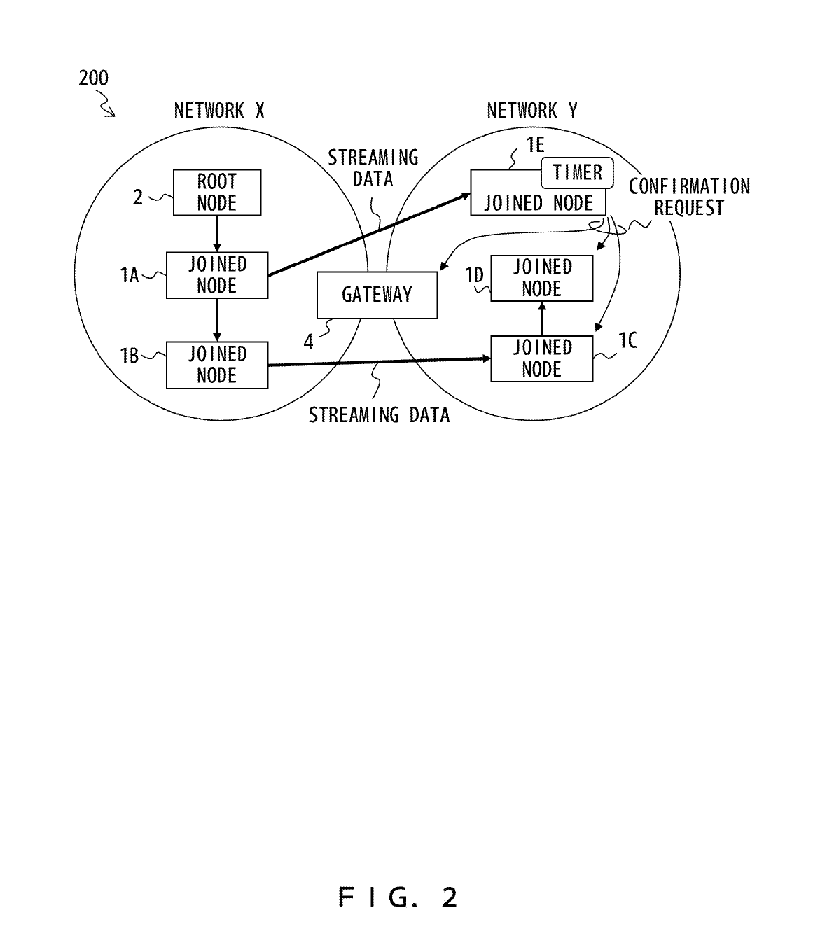

Next, joined node device 1E transmits a multicast confirmation request to all node devices belonging to network Y as illustrated in FIG. 2. A confirmation request can inquire whether or not streaming data can be delivered (or whether or not it is possible to operate as a parent node device). This multicast confirmation request is stored in a multicast packet to which a multicast address used in network Y is added. Also, “Time To Live (TTL)=1” is added to this multicast confirmation request. TTL is decremented by one by a gateway (router) that receives the packet in a packet forwarding process. When the TTL added to the packet has become zero, that packet is not forwarded thereafter. Accordingly, a multicast confirmation request in which TTL=1 is set is received by a node device located within a range of one hop from joined node device 1E. In other words, a multicast confirmation request transmitted from joined node device 1E is received by each node device (joined node devices 1C and 1D in FIG. 2) in network Y.

This multicast confirmation request is also received by the gateway 4. However, the TTL of the multicast confirmation request is updated from one to zero in the gateway 4. Accordingly, the multicast confirmation request is not forwarded to network X.

When transmitting the multicast confirmation request described above, joined node device 1E activates a timer. This timer measures the RTT between joined node device 1E and the parent node device (i.e., joined node device 1A). Note that joined node device 1E has previously measured the RTT in FIG. 1. Then joined node device 1E waits for a confirmation response corresponding to the multicast confirmation request up to the time when the timer expires.

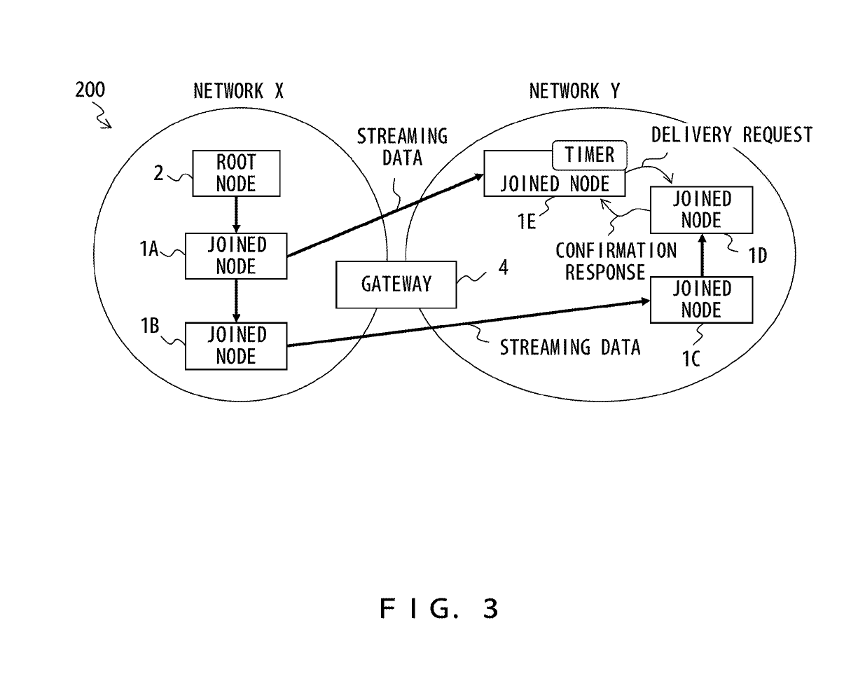

Joined node devices that have received a multicast confirmation request respectively decide whether or not to respond to that confirmation request. A joined node device that can deliver streaming data to another node device (for example, a newly-joined node device) responds to the received confirmation request. In such a case, the joined node device that has received the confirmation request returns a confirmation response to the source node device of the confirmation request. In the example illustrated in FIG. 3, joined node devices 1C and 1D have received the multicast confirmation request, and joined node device 1D returns a confirmation response to joined node device 1E. A joined node device that is not able to deliver streaming data to the newly-joined node device discards the received confirmation request. In addition, a node device that has not joined the streaming service also discards a received confirmation request.

It is assumed that joined node device 1E receives a confirmation response from joined node device 1D before the timer described above expires. This timer measures the RTT between joined node device 1E and the parent node device (i.e., joined node device 1A) as described above. Accordingly, when joined node device 1E receives a confirmation response before the timer expires, joined node device 1E decides that a joined node device that can deliver streaming data located at a closer position comparing with the current parent node device. In such a case, joined node device 1E specifies a joined node device that returned the confirmation response and transmits a delivery request to the specified joined node device. In the example illustrated in FIG. 3, joined node device 1E transmits a delivery request to joined node device 1D.

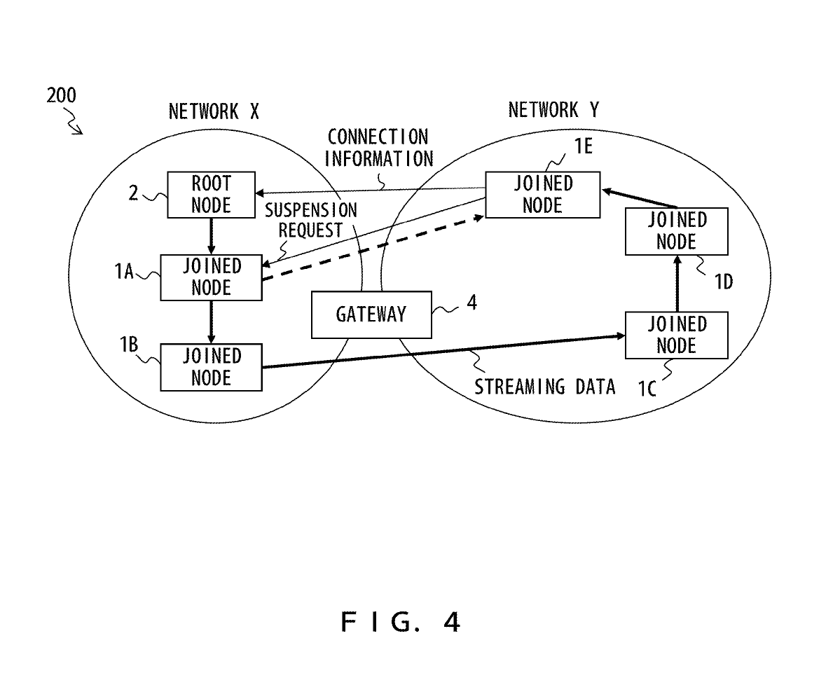

As illustrated in FIG. 4, joined node device 1D starts streaming delivery to joined node device 1E in accordance with the delivery request. Then, joined node device 1E receives streaming data from both of joined node devices 1A and 1D. When the streaming data received from joined node device 1D has become stable, joined node device 1E transmits a delivery suspension request to joined node device 1A. This procedure realizes the switching from current parent node device to new parent node device in joined node device 1E without interruption of streaming data. Thereafter, joined node device 1D will operate as the parent node device for joined node device 1E.

Thereafter, joined node device 1E transmits connection information to the root node device 2. Connection information includes information for identifying a source node device of streaming data. In this example, connection information includes information for identifying node device 1D. Upon receiving connection information from joined node device 1E, the root node device 2 updates the delivery tree information. Delivery tree information represents connection relationships between node devices that have joined a streaming service. In other words, delivery tree information represents a delivery route of streaming data from the root node device 2 to each joined node device.

When joined node device 1E has received a plurality of confirmation responses before the timer expires, joined node device 1E transmits a delivery request to the joined node device that first returned a confirmation response. In such a case, joined node device 1E can receive streaming data from the joined node device located closest to joined node device 1E.

As described above, joined node device 1E decides whether or not a joined node device that can deliver streaming data (i.e., a candidate for a more preferable parent node device) is located closer to joined node device 1E comparing with the current parent node device. When there is such a node device, joined node device 1E switches the parent node devices. Accordingly, this method reduces delay times of streaming data.

Each joined node device may periodically perform the procedure of searching for a preferred parent node device by utilizing the multicast confirmation request described above. However, a joined node device does not have to conduct this search when a parent node device is located close to the joined node device. Thus, a joined node device may decide whether or not the parent node device is located closer to the joined node device comparing with the router or the gateway accommodating the joined node device.

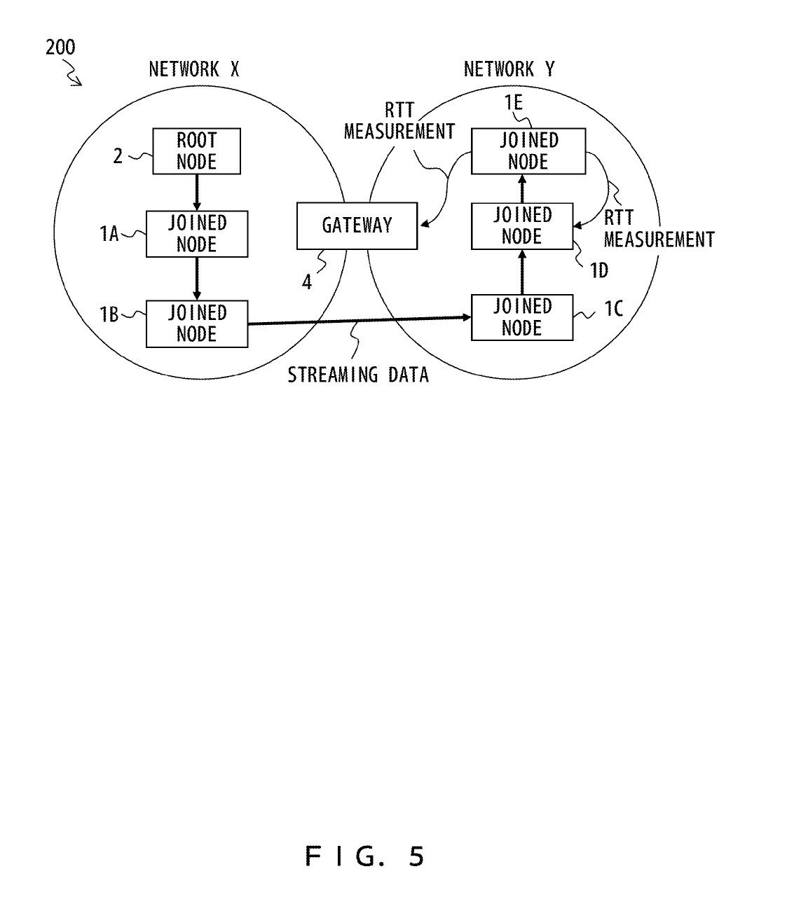

In such a case, joined node device 1E measures the RTT between joined node device 1E and the gateway 4 as illustrated in FIG. 5. Joined node device 1E also measures the RTT between joined node device 1E and the parent node device (joined node device 1D in this example). When the RTT with respect to joined node device 1D is shorter than the RTT with respect to the gateway 4, joined node device 1E decides that the current parent node device is a preferable parent node device. In such a case, joined node device 1E does not conduct a search for a new parent node device. In other words, joined node device 1E continues to receive streaming data from joined node device 1D. When the RTT with respect to joined node device 1D is longer than the RTT with respect to gateway 4, joined node device 1E decides that the current parent node device is not a preferable node device. In such a case, joined node device 1E searches for a new parent node device. In other words, joined node device 1E searches for a preferable parent node device by utilizing a multicast confirmation request as illustrated in FIGS. 1-4.

Each joined node device decides in advance whether or not it is possible to deliver streaming data to a new node device. When for example the hardware resources (the CPU, a memory, etc.) of a joined node device have a sufficiently high performance, the joined node device decides that it is possible to deliver streaming data. However, when the usage rate of the hardware resources of a joined node device is high, that node device decides that it is not possible to deliver a data stream. A joined node device may perform the above decision based on the configuration of the delivery tree. When, for example, a large number of joined node devices are located between the root node device 2 and a node device, that node device decides that it is not possible to deliver streaming data. Note that the delivery tree information that represents the configuration of the delivery tree is reported from the root node device 2 to each joined node device. Then, a joined node device that has decided that it is possible to deliver streaming data returns a confirmation response when it receives a multicast confirmation request. A joined node device that has decided that it is not possible to deliver streaming data does not return a confirmation response even when it receives a multicast confirmation request.

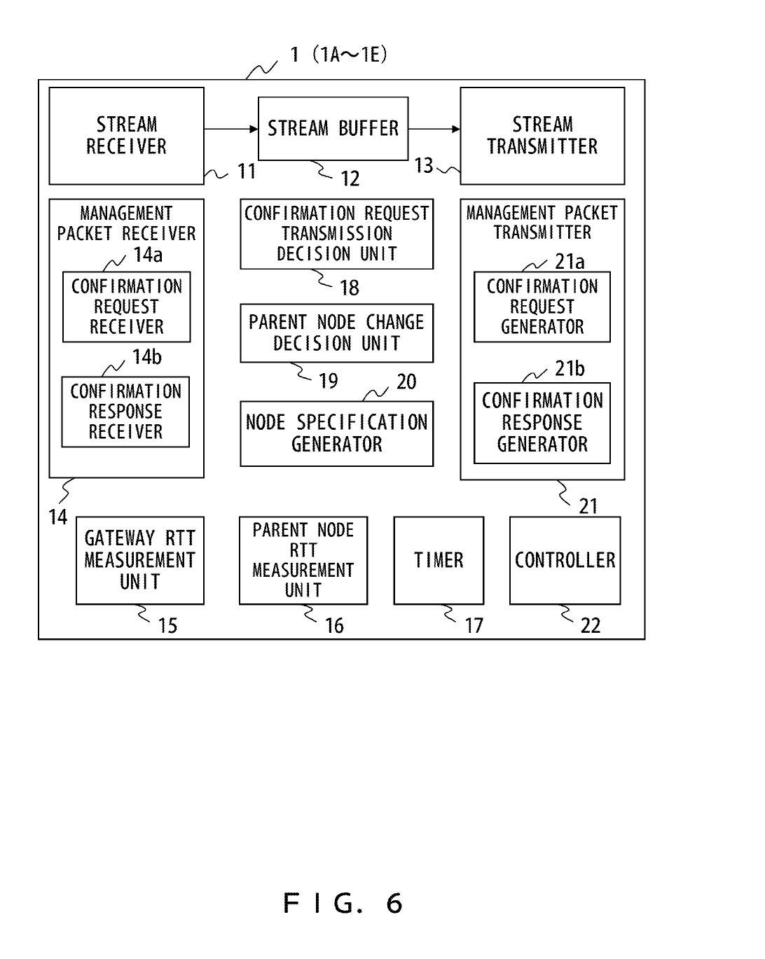

FIG. 6 is a block diagram illustrating functions of a node device. Node devices 1 (1A-1E) each have a stream receiver 11, a stream buffer 12, a stream transmitter 13, a management packet receiver 14, a gateway RTT measurement unit 15, a parent node RTT measurement unit 16, a timer 17, a confirmation request transmission decision unit 18, a parent node change decision unit 19, a node specification generator 20, a management packet transmitter 21, and a controller 22, as illustrated in FIG. 6. The node device 1 may have additional functions which are not illustrated in FIG. 6. The functions illustrated in FIG. 6 may be realized by executing a program using a computer.

The stream receiver 11 receives streaming data from the root node device 2 or a joined node device on the upstream side. The stream receiver 11 stores the streaming data in the stream buffer 12. The stream transmitter 13 reads the streaming data from the stream buffer 12 and transmits the read streaming data to a joined node device on the downstream side. Note that a display device and/or a speaker (not illustrated) may be connected to the node devices 1. In such a case, a video is displayed on the display device and audio is output via the speaker based on streaming data written in the stream buffer 12.

The management packet receiver 14 receives a management packet from the root node device 2 or a different node device. The management packet receiver 14 includes a confirmation request receiver 14a and a confirmation response receiver 14b. The confirmation request receiver 14a receives a management packet containing a multicast confirmation request transmitted from a different joined node device. The confirmation response receiver 14b receives a management packet containing a confirmation response corresponding to the multicast confirmation request. However, after the timer 17 has expired, the confirmation response receiver 14b discards a management packet containing confirmation response. Also, when the confirmation response receiver 14b has received a plurality of management packets respectively containing confirmation responses, the confirmation response receiver 14b accepts the first management packet and discards the subsequent management packets. The management packet receiver 14 can receive a different management packet. For example, the management packet receiver 14 receives a management packet containing a delivery request, and receives other information.

The gateway RTT measurement unit 15 measures the RTT with respect to the router or the gateway that accommodates the node device 1. In the example illustrated in FIG. 5, the gateway RTT measurement unit 15 measures the RTT with respect to the gateway 4. The parent node RTT measurement unit 16 measures the RTT with respect to the parent node device. In the example illustrated in FIG. 1, the RTT with respect to joined node device 1A is measured, and in the example illustrated in FIG. 5, the RTT with respect to joined node device 1D is measured. The gateway RTT measurement unit 15 and the parent node RTT measurement unit 16 may measure RTT by using for example Ping.

RTT measured by the parent node RTT measurement unit 16 is set in the timer 17. The timer 17 is activated when the management packet transmitter 21 transmits a management packet containing a multicast confirmation request. When the timer 17 has expired, an expiration report is given to the confirmation response receiver 14b.

The confirmation request transmission decision unit 18 compares RTT measured by the gateway RTT measurement unit (gateway RTT) and RTT measured by the parent node RTT measurement unit 16 (parent node RTT). Then, as explained by referring to FIG. 5, when the parent node RTT is shorter than the gateway RTT, the confirmation request transmission decision unit 18 decides that it is not necessary to search for a new parent node device by using a multicast confirmation request. When the parent node RTT is longer than the gateway RTT, the confirmation request transmission decision unit 18 decides that it is necessary to search for a new parent node device and gives the management packet transmitter 21 an instruction to transmit a multicast confirmation request.

When the confirmation response receiver 14b receives the corresponding confirmation response during a period between when the management packet transmitter 21 transmitted a multicast confirmation request and when the timer 17 expired, the parent node change decision unit 19 executes a process of changing the parent node device. For this process, the parent node change decision unit 19 generates a delivery request. The destination of this delivery request is the source node device of the confirmation response that the confirmation response receiver 14b first received. Also, the parent node change decision unit 19 generates a delivery suspension request. The destination of this delivery suspension request is the current parent node device.

The node specification generator 20 manages node specification information for deciding whether or not the node device 1 (i.e., the node device of the node specification generator 20) is capable of delivering streaming data. Node specification information includes information representing the performance and the state of the hardware of the node device 1, information representing the state of the delivery tree, and other pieces of information.

The management packet transmitter 21 transmits a management packet to the root node device 2 and a different node device. The management packet transmitter 21 includes a confirmation request generator 21a and a confirmation response generator 21b. The confirmation request generator 21a transmits a management packet containing the multicast confirmation request illustrated in FIG. 2 to node devices within a specified range. In other words, a multicast address for specified range is set as a destination address in this management packet. Also, the confirmation request generator 21a adds “TTL=1” to this management packet. When the confirmation request receiver 14a receives a confirmation request from a different joined node device, the confirmation response generator 21b returns a management packet containing a confirmation response corresponding to that confirmation request. However, when the node device 1 (i.e., the node device of the confirmation response generator 21b) is not capable of delivering streaming data, the confirmation response generator 21b does not return a confirmation response.

The management packet transmitter 21 may also transmit a different management packet. In other words, the management packet transmitter 21 can transmit a management packet containing the delivery request illustrated in FIG. 3, a management packet containing the delivery suspension request illustrated in FIG. 4, a management packet containing the connection request illustrated in FIG. 4, and other information.

The controller 22 controls the operations of the node device 1. The controller 22 provides other functions related to streaming delivery. For example, the controller 22 may select a parent node device based on candidate parent node information received from the root node device 2.

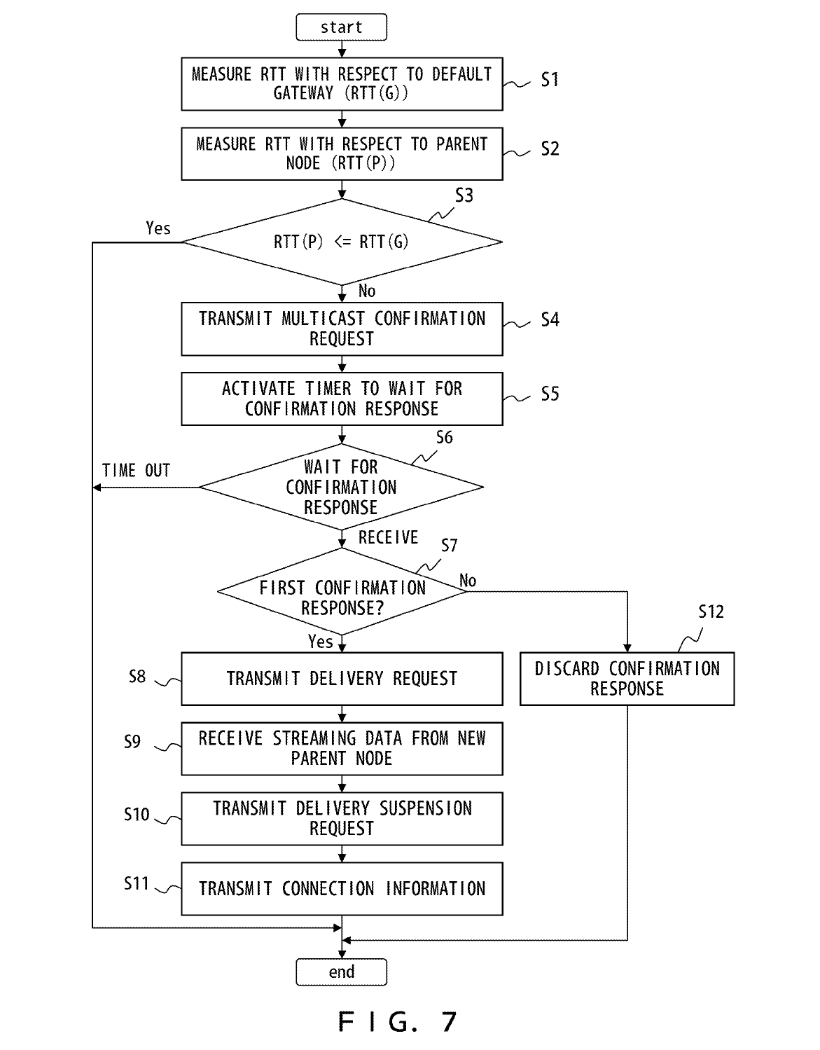

FIG. 7 is a flowchart illustrating operations of a node device. The process in this flowchart is executed after the node device started the reception of streaming data. The process illustrated in FIG. 7 may be realized by executing a program using a computer.

In S1, the gateway RTT measurement unit 15 measures the RTT with respect to the default gateway. The default gateway is a router or a gateway that accommodates the node device of the gateway RTT measurement unit 15. In the example illustrated in FIGS. 1-5, the RTT with respect to the gateway 4 is measured. In S2, the parent node RTT measurement unit 16 measures the RTT with respect to the parent node device. In the example illustrated in FIG. 1, the RTT with respect to joined node device 1A is measured.

In S3, the confirmation request transmission decision unit 18 compares the RTT measured by the gateway RTT measurement unit 15 (RTT(G)) and the RTT measured by the parent node RTT measurement unit 16 (RTT(P)). When the RTT(G) is longer than or equal to the RTT(P), the confirmation request transmission decision unit 18 decides that it is not necessary to transmit a multicast confirmation request. In such a case, the process of the joined node device terminates. When the RTT(P) is longer than the RTT(G), the confirmation request transmission decision unit 18 gives the management packet transmitter 21 an instruction to transmit a multicast confirmation request.

In S4, the confirmation request generator 21a transmits a multicast confirmation request to node devices within a specified range. In a management packet containing a multicast confirmation request, “TTL=1” is set. Thus, the multicast confirmation request is received by node devices within a one-hop range from the joined node device of the confirmation request generator 21a. Also, the confirmation request generator 21a activates the timer 17 in S5 when transmitting a multicast confirmation request. The timer 17 will expire when the RTT(P), measured in S2, with respect to the parent node device expires.

In S6, the confirmation response receiver 14b waits for a confirmation response corresponding to the multicast confirmation request transmitted in S4. When the confirmation response receiver 14b receives a confirmation response before the timer 17 expires, the process in the node device proceeds to S7. In S7, the confirmation response receiver 14b decides whether or not the received confirmation response is the first confirmation response. When the confirmation response receiver 14b receives the first confirmation response, the process in the node device proceeds to S8. When the confirmation response receiver 14b receives the second or subsequent confirmation responses, the received confirmation responses are discarded in S12.

In S8, the controller 22 specifies a new parent node device. In such a case, the source node device of the first confirmation response is specified as a new parent node device. The management packet transmitter 21 transmits a delivery request to the new parent node device specified by the controller 22. Then, this new parent node device starts the requested streaming data delivery.

In S9, the stream receiver 11 receives streaming data from the new parent node device. Then, the stream receiver 11 receives streaming data from both the current parent node device and the new parent node device. When the streaming data received from the new parent node device has become stable, in S10, the controller 22 transmits a delivery suspension request to the current parent node device via the management packet transmitter 21. Thereafter, in S11, the controller 22 transmits a connection request to the root node device 2 via the management packet transmitter 21. Thereby, the delivery tree information is updated in the root node device 2.

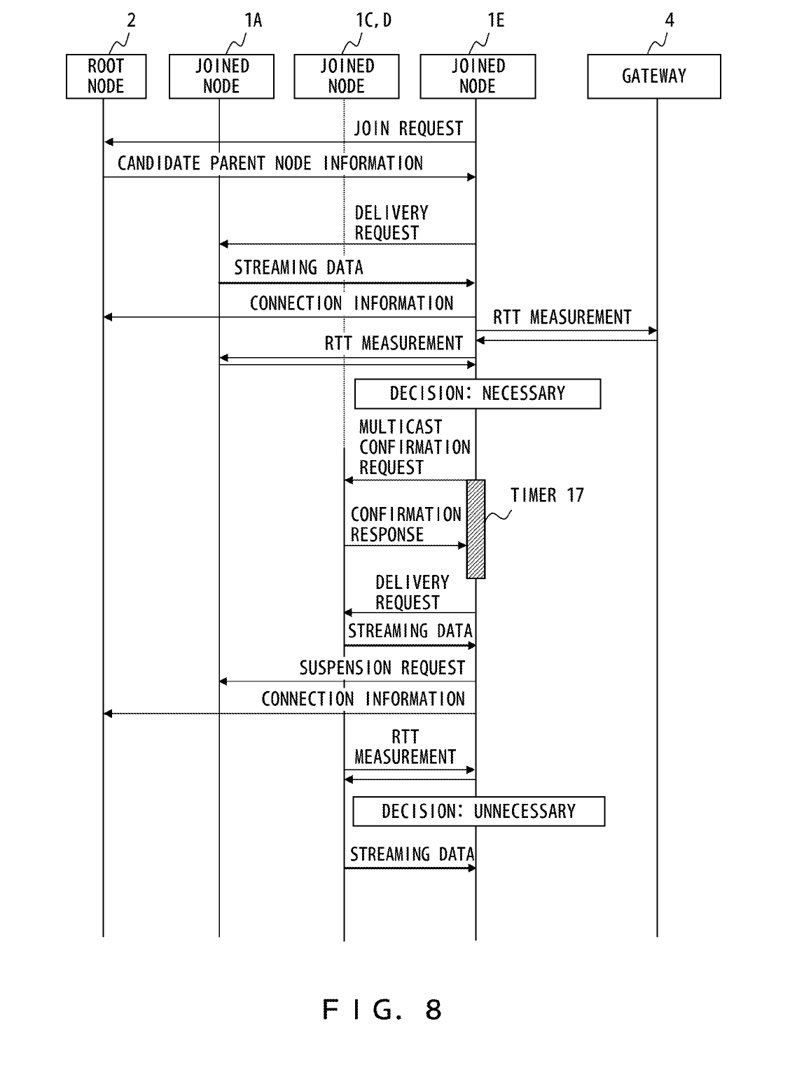

FIG. 8 is a sequence diagram in which a preferable parent node device is selected. In the description below, it is assumed that streaming data is being delivered from the root node device 2 to joined node devices 1A-1D in the video streaming system 200 illustrated in FIGS. 1-5. It is also assumed that node device 1E newly joins the streaming service.

In such a case, node device 1E transmits a join request to the root node device 2. The root node device 2 generates candidate parent node information and returns the information to node device 1E. In such a case, the candidate parent node information includes a list of joined node devices that can operate as a parent node device for node device 1E. Node device 1E selects a parent node device by using the candidate parent node information received from the root node device 2 and transmits a delivery request to that parent node device. In the example illustrated in FIG. 8, node device 1E transmits a delivery request to joined node device 1A and then streaming data is delivered from joined node device 1A to node device 1E. Thereafter, node device 1E transmits to the root node device 2 connection information indicating that joined node device 1A is the parent node device. As a result of this, the situation illustrated in FIG. 1 is achieved.

Node device 1E measures the gateway RTT that represents the round trip time with respect to the gateway 4. Also, node device 1E measures the parent node RTT that represents the round trip time with respect to the parent node device (joined node device 1A in this example). Then, node device 1E compares the gateway RTT and the parent node RTT so as to decide whether or not to execute the process of searching for a more preferable parent node device than the current parent node device. It is assumed in this example that the parent node RTT is longer than the gateway RTT and node device 1E executes the search.

Node device 1E transmits a multicast confirmation request to node devices belonging to network Y. At that moment, the timer 17 is activated. This multicast confirmation request is received by joined node devices 1C and 1D. In this example, it is assumed that only joined node device 1D returns a confirmation response to node device 1E.

Before the timer 17 expires, node device 1E receives a confirmation response returned from joined node device 1D. In such a case, node device 1E decides that a joined node device that can deliver streaming data (i.e., joined node device 1D) is located at a closer position comparing with the current parent node device (i.e., joined node device 1A). In such a case, node device 1E transmits a delivery request to joined node device 1D. Then, joined node device 1D starts the delivery of streaming data to node device 1E. Also, node device 1E transmits a delivery suspension request to the current parent node device (i.e., joined node device 1A). Further, node device 1E transmits to the root node device 2 connection information indicating that joined node device 1D is the parent node device. The root node device 2 updates the delivery tree information in accordance with this connection information. By this procedure, the switching of parent node devices is completed.

Further, node device 1E measures a new parent node

RTT that represents the round trip time with respect to the new parent node device (i.e., joined node device 1D). Node device 1E compares the gateway RTT and the new parent node RTT. It is assumed in this example that the new parent node RTT is shorter than the gateway RTT. In such a case, the new parent node device is decided to be a preferable parent node device. Accordingly, node device 1E thereafter receives streaming data from joined node device 1D.

Although “TTL=1” is added to a multicast confirmation request in the above example, the present invention is not limited to this method. In other words, it is not necessary to set the TTL in a multicast confirmation request. When a TTL is not set in a multicast confirmation request, a node device that has transmitted a multicast confirmation request may receive a confirmation response from a joined node device that is located two or more hops away. However, when a plurality of confirmation responses have been received, the node device decides a new parent node device based on the confirmation response that was first received. Accordingly, there is a low possibility that a joined node device that is located two or more hops away from the node device will be selected as a parent node device.

<Hardware Configuration of Node Device>

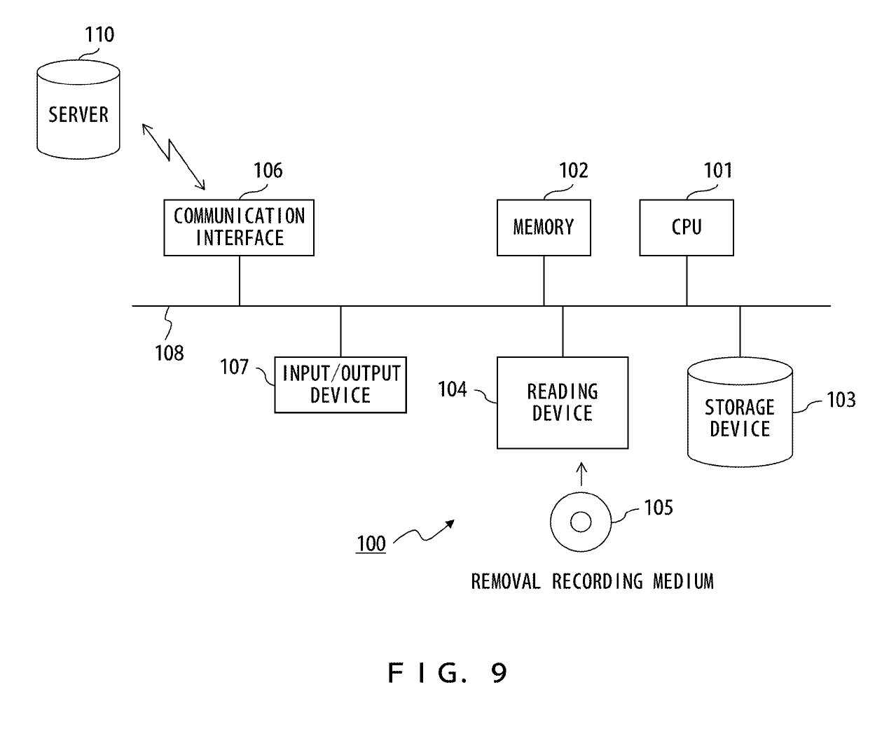

FIG. 9 illustrates an example of a hardware configuration of a node device according to an embodiment of the present invention. A node device includes a computer system 100 illustrated in FIG. 9. The computer system 100 includes a CPU 101, a memory 102, a storage device 103, a reading device 104, a communication interface 106, and an input/output device 107. The CPU 101, the memory 102, the storage device 103, the reading device 104, the communication interface 106 and the input/output device 107 are connected with each other via for example a bus 108.

The CPU 101 executes a streaming data reception program that describes the process of the flowchart illustrated in FIG. 7 by using the memory 102. Thereby, the streaming data reception method described above is realized. The memory 102 is for example a semiconductor memory, and includes a RAM area and a ROM area. The storage device 103 is for example a hard disk device, and stores the streaming data reception program described above. Also, the storage device 103 may store streaming data. Note that the storage device 103 maybe a semiconductor memory such as a flash memory etc. Also, the storage device 103 maybe an external recording device.

The reading device 104 accesses a removal recording medium 105 in accordance with an instruction from the CPU 101. The removal recording medium 105 is implemented by for example a semiconductor device (a USB memory or the like), a medium that information is input into and output from by the use of magnetic effects (a magnetic disk or the like), a medium that information is input into and output from by the use of optical effects (a CD-ROM, a DVD or the like), etc. The communication interface 106 can transmit and receive data via a network in accordance with an instruction from the CPU 101. The input/output device 107 includes a device that receives instructions from users, a device that outputs streaming data, and other devices.

The streaming data reception program according to the embodiments is provided to the computer system 100 in for example the following forms.

(1) Installed in the storage device 103
(2) Provided from the removal recording medium 105
(3) Provided from a program server 110

As described above, according to the embodiments of the invention, a joined node device can receive streaming data from a preferable parent node device in a streaming system that performs streaming delivery based on P2P.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A node device used in a streaming system that provides a streaming service, the node device comprising:
a measurement unit configured to measure a first response time representing a round trip time with respect to a first node device that is a source of streaming data;
a confirmation request generator configured to transmit a confirmation request for confirming whether delivery of streaming data is available to a node device within a specified range; and
a transmitter configured to transmit a delivery request to a second node device that returns a confirmation response corresponding to the confirmation request during a period from when the confirmation request generator transmits the confirmation request until when the first response time elapses.

2. The node device according to claim 1, wherein
the confirmation request generator transmits the confirmation request to a node device within a range in which TTL (Time To Live) is one.

3. The node device according to claim 1, wherein
the measurement unit measures a second response time representing a round trip time with respect to a router or a gateway that accommodates the node device, and
the confirmation request generator transmits the confirmation request when the first response time is longer than the second response time.

4. The node device according to claim 1, wherein
the transmitter requests the first node device to suspend streaming delivery after starting reception of streaming data delivered from the second node device.

5. A streaming data reception method used in a node device that joins a streaming service in a streaming system, the streaming data reception method comprising:
measuring a round trip time with respect to a first node device that is a source of streaming data;
transmitting a confirmation request for confirming whether delivery of streaming data is available to a node device within a specified range; and
transmitting a delivery request to a second node device that returns a confirmation response corresponding to the confirmation request during a period from when the confirmation request is transmitted until when the round trip time elapses.

6. A non-transitory computer-readable recording medium having stored therein a program for causing a computer in a node device that joins a streaming service in a streaming system to execute a streaming data receiving process, the process comprising:
measuring a round trip time with respect to a first node device that is a source of streaming data;
transmitting a confirmation request for confirming whether delivery of streaming data is available to a node device within a specified range; and
transmitting a delivery request to a second node device that returns a confirmation response corresponding to the confirmation request during a period from when the confirmation request is transmitted until when the round trip time elapses.

7. A streaming system that provides a streaming service to a node device, the streaming system comprising:
a first node device that is a source of streaming data; and
a joined node device that has joined the streaming service, wherein
the joined node device measures a round trip time with respect to the first node device,
the joined node device transmits a confirmation request for confirming whether delivery of streaming data is available to a node device within a specified range,
the joined node device transmits a delivery request to a second node device that returns a confirmation response corresponding to the confirmation request during a period from when the confirmation request is transmitted until when the round trip time elapses, and
the second node device delivers streaming data to the joined node device in response to the delivery request.
